(19) United States
(12) Patent Application Publication
(10) Pub. No.: US 2026/0299636 A1
(43) Pub. Date: Oct. 1, 2026

(54) MULTI-DIRECTIONAL INPUT DEVICE, CONTROLLER HAVING THE MULTI-DIRECTIONAL INPUT DEVICE, AND CONTROL APPARATUS HAVING THE CONTROLLER

(71) Applicant: SHENZHEN ZESUM TECHNOLOGY CO., LTD, Shenzhen (CN)

(72) Inventors: YUSHO NAKASE, Shenzhen (CN); Xian-Wu Hu, Shenzhen (CN); Chao-Xian Chen, Shenzhen (CN)

(21) Appl. No.: 19/357,350

(22) Filed: Oct. 14, 2025

(30) Foreign Application Priority Data
Mar. 25, 2025 (CN) 202510357802.6

(51) Int. Cl. G05G 9/047

(52) U.S. Cl. CPC G05G 9/047; G05G 2505/00

(57) ABSTRACT

A multi-directional input device includes a housing defines a cavity with an opening, an operation member at least partially disposed within the cavity, and a resetting assembly located inside the cavity. The operation member, which tilts or swings when acted upon by an external force, includes an operation body with a first end protruding through the housing's opening and an abutting portion arranged around the operation body's periphery. This abutting portion has a bottom surface, facing away from the first end, which features at least two interconnected abutting edges. The resetting assembly elastically abuts this bottom surface and is configured to selectively abut against one of the abutting edges when the operation member is tilted or swung. The disclosure also provides a controller and a control apparatus including the input device.

### CROSS-REFERENCE TO RELATED APPLICATIONS

The present application claims the benefit and priority to Chinese Patent Application Serial No. 202510357802.6, filed on May 25, 2025, in China State Intellectual Property Administration, and the content of which is hereby fully incorporated by reference into the present application.

### FIELD

The subject matter relates to input devices, particularly to a multi-directional input device, a controller having the multi-directional input device, and a control apparatus having the controller.

### BACKGROUND

Multi-directional input devices are increasingly used in controllers such as game consoles and unmanned aerial vehicles. An existing input device may rely on various structural components to realize operations along X and Y directions. For example, springs may be included in the input device, and when an operator rotates or tilts an operating rod of the input device, switching between the springs provides a detent sensation and a changing rebounding force. However, such structural components may be complex, which increase manufacturing cost.

### BRIEF DESCRIPTION OF THE DRAWINGS

Implementations of the present technology will now be described, by way of example only, with reference to the attached FIG.s, wherein:

FIG. 1 is a schematic view of a multi-directional input device according to an embodiment of the present application.

FIG. 2 is an exploded view of the input device shown in FIG. 1.

FIG. 3 is a schematic view of the input device of FIG. 1 with a cover assembled.

FIG. 4 is a cross-sectional view taken along line A–A of FIG. 3.

FIG. 5 is a cross-sectional view of the input device of FIG. 3 in another operating state.

FIG. 6 is a schematic view of an operation member of the input device of FIG. 1.

FIG. 7 is a schematic view of another embodiment of the operation member of FIG. 1.

FIG. 8 is a block diagram of a controller according to an embodiment.

FIG. 9 is a block diagram of a control apparatus according to an embodiment.

### DETAILED DESCRIPTION

It will be appreciated that for simplicity and clarity of illustration, where appropriate, reference numerals have been repeated among the different FIG.s to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale

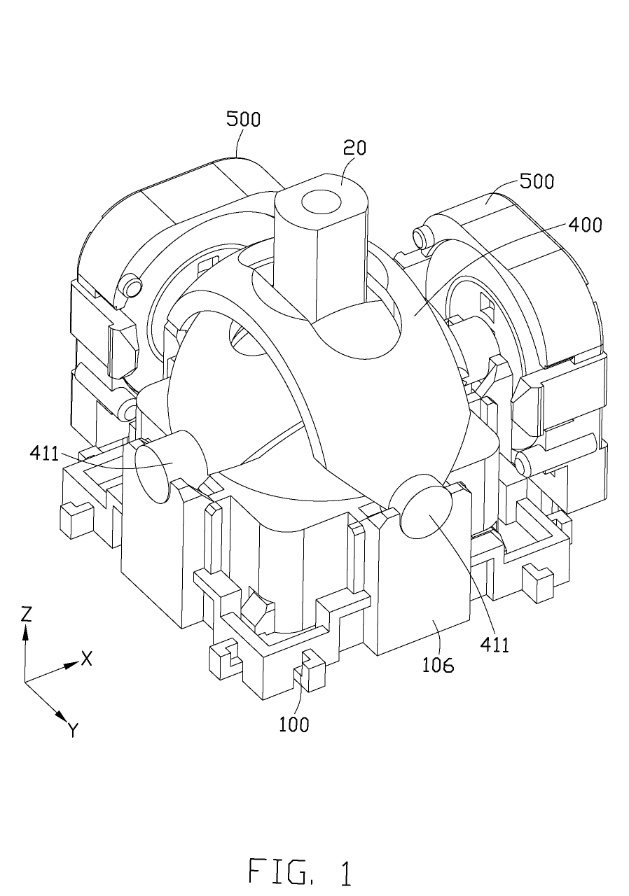

Referring to FIGS. 1-4, a multi-directional input device 10 is provided according to an embodiment of the present application. The multi-directional input device 10 includes a housing 100, an operation member 20, and a resetting assembly 300. The housing 100 defines a cavity 101 and an opening 104 communicating with the cavity 101. At least a portion of the operation member 20 is disposed in the cavity 101 and can be tilted or swung under an external force. The operation member 20 includes an operation body 200 and an abutting portion 210 arranged around a periphery of the operation body 200. The operation body 200 includes a first end 201 that protrudes from the opening 104. The abutting portion 210 includes a bottom surface 212 facing away from the first end 201. The bottom surface 212 includes at least two abutting edges 213 connected to each other. The resetting assembly 300 is disposed in the cavity 101 and elastically abutted against the bottom surface 212. When at least the portion of the operation member 20 is titled within the cavity 101, the resetting assembly 300 is selectively abutted against one of the abutting edges 213.

In the multi-direction input device 10 of the embodiment, the abutting portion 210 includes the bottom surface 212 opposite to the first end 201, and the bottom surface 212 includes at least two abutting edges 213 connected to each other. When the operation member 20 is tilted, one of the abutting edges 213 can press against the resetting assembly 300. When the operator reverses the direction of the force applied on the operation member 20, the resetting assembly 300 may be resisted against the bottom surface 212 again and then switch to another one of the abutting edges 213. With this configuration, a detent sensation can be preserved and, by virtue of the change in the direction of the rebounding force produced by the same resetting assembly 300, a user may obtain a consistent tactile feeling among different operating directions. In addition, because only one resetting assembly 300 is involved, the structure of the multi-directional input device 10 can be simplified, the number of components required in the multi-directional input device 10 can be reduced, and manufacturing cost can be reduced.

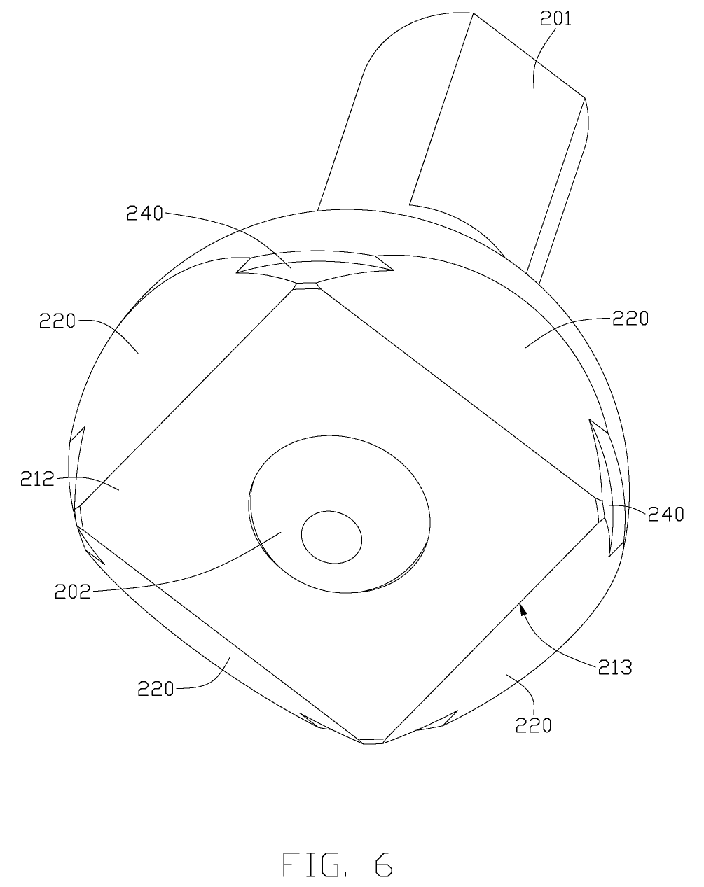

Referring also to FIG. 6, in one embodiment, the abutting edges 213 include four abutting edges connected to each other. Two of the four abutting edges 213 are parallel to each other, and the four abutting edges 213 cooperatively define the bottom surface 212. Specifically, the four abutting edges 213 include two abutting edges 213 opposite to each other along a first direction X and two abutting edges 213 opposite to each other along a second direction Y, and the first direction X and the second direction Y are perpendicular to each other. The abutting portion 210 has multiple operation surfaces 220 on an outer wall of the abutting portion 210. Each operation surface 220 is perpendicular or inclined relative to the bottom surface 212, and connected to the bottom surface 212 at a corresponding abutting edge 213. A transition surfaces 240 may be provided between two adjacent operation surfaces 220. The bottom surface 212 may be quadrilateral.

In applications such as game controllers or unmanned-aerial-vehicle flight control, the first direction X may correspond to a forward/backward movement, and the second direction Y may correspond to a left/right movement. The bottom surface 212 may be quadrilateral. By providing the operation surfaces 220, a more consistent operating feeling can be obtained while maintaining a pronounced detent sensation. The structure of the multi-directional input device 10 may be simplified and the number of the components required therein is reduced. The transition between two adjacent operation surfaces 220 via the corresponding transition surface 240 can provide clearer tactile feedback, which assists the user in perceiving and controlling each direction, and enables a more natural and comfortable hand posture to reduce fatigue during a long time use. The smooth transition between different operation surfaces 220 may further reduce abruptness when switching directions, decrease the likelihood of mis-operation, and improve continuity of manipulation. In addition, the transition surfaces 240 can offer supplementary tactile feedback so that the user may perceive different directional inputs, thereby enhancing the naturalness, comfort, and efficiency of interaction in precision-control scenarios.

In other embodiments, the number of the abutting edges 213 may be more than four, for example, the number of the abutting edges 213 may be six or eight. In this case, the bottom surface 212 is hexagonal or octagonal, and the number of the operation surfaces 220 corresponds to the number of the abutting edges 213.

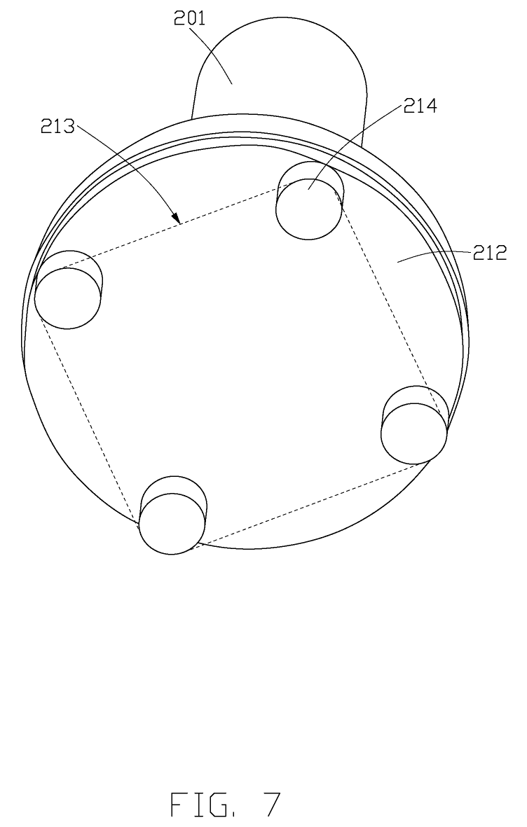

Referring to FIG. 7, in another embodiment, a plurality of posts 214 extend from the bottom surface 212 away from the first end 201, and an abutting edge 213 is defined between adjacent posts 214. Optionally, the number of the posts 214 may be four, six, or eight, thereby defining a quadrilateral, hexagonal, or octagonal contour at the bottom surface 212.

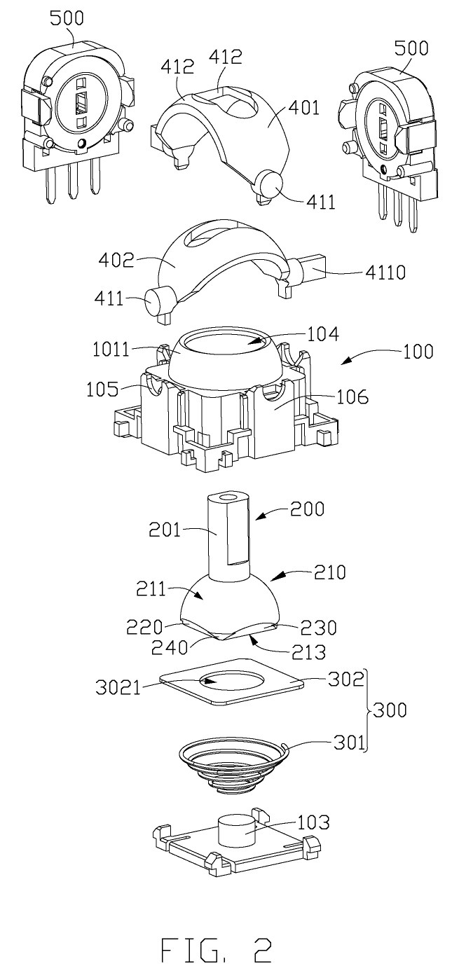

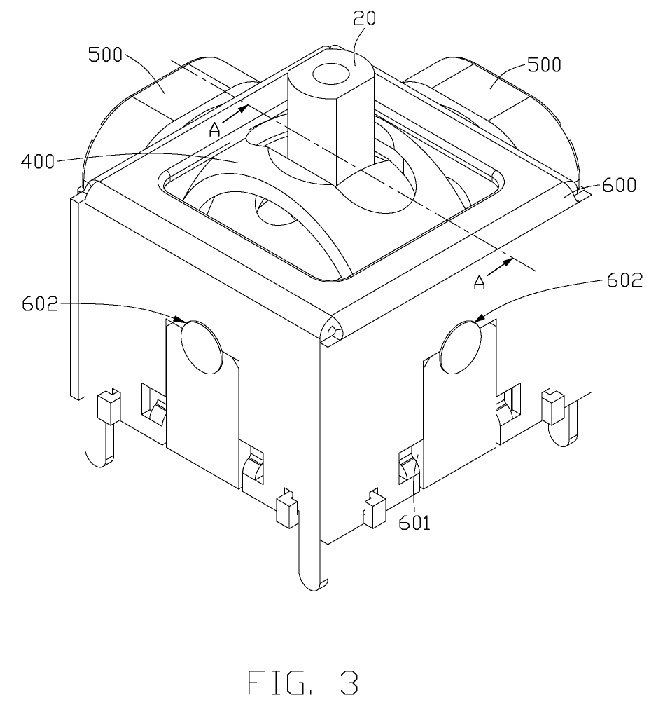

Referring to FIGS. 2 and 3, the device 10 may further include a rocker arm assembly 400 rotatably disposed on the housing 100. The operation member 20 is drivingly connected to the rocker arm assembly 400. The rocker arm assembly 400 is configured to rotate relative to the housing 100 when the operation member 20 swings.

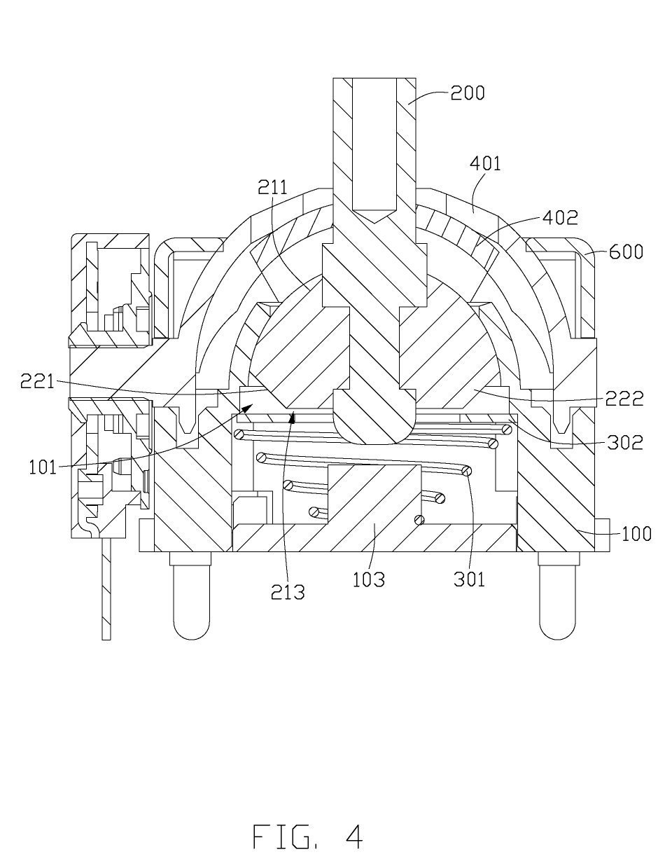

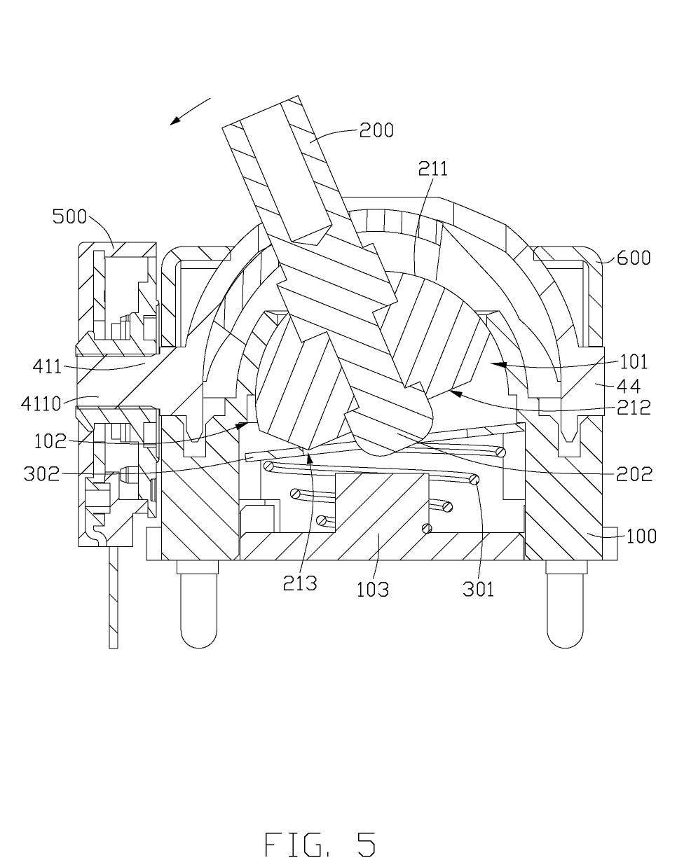

Referring to FIGS. 4 and 5, in some embodiments, the rocker arm assembly 400 includes a first swing arm 401 and a second swing arm 402 with rotational axes perpendicular to each other. The first swing arm 401 and the second swing arm 402 are stacked with each other. When one of the abutting edges 213 is abutted against the resetting assembly 300, the operation member 20 is configured to drive the first swing arm 401 or the second swing arm 402 to rotate relative to the housing 100.

When the operator inputs along the first direction X, a more direct mechanical feedback can be obtained, enhancing operational stability and the clarity of signal transmission. When an abutting edge 213 abuts against the resetting assembly 300, the operation body 200 drives the second swing arm 402 to rotate relative to the housing 100. Such a rotational design—where the first swing arm 401 and the second swing arm 402 are independent yet cooperatively coupled—makes the response of the operation body 200 more sensitive for inputs in two different directions and provides a smoother user experience. Moreover, this design ensures coordination during multi directional movement, avoiding conflicts or stiction that may occur during operation. In applications involving fine adjustment or rapid response, it helps improve efficiency. Whether performing simple operations or complex tasks, the operator can maintain a good sense of control, thereby improving working efficiency and satisfying individualized needs. Overall, provision of the rocker arm assembly 400 renders multi directional input more natural and enhances the human–machine interaction experience of the device.

Referring to FIG. 2, at least one of the first swing arm 401 and the second swing arm 402 includes an arm body 410 and rotating portions 411 located at two ends of the arm body 410. The housing 100 defines a first recess 105, and a rotating portion 411 is rotatably received in the first recess 105 to position the swing arm relative to the housing 100. The arm body 410 may be C-shaped to provide a high strength and stability. The rotating portion 411 is rotatably disposed in the first recess 105 of the housing 100, allowing the arm body 410 to rotate flexibly during operation. The first recess 105 provided in the housing 100 locates the first swing arm 401 or the second swing arm 402 so that the first swing arm 401 or the second swing arm 402 remains stable while rotating, thereby avoiding displacement or unnecessary wear caused by external forces or mis operation.

Referring to FIGS. 1 and 2, the arm body 410 defines a slot 412, and at least a portion of the slot 412 extends along the direction of the swing arm. The first end 201 passes through and slides within the slot 412. The first end 201 is configured to, when moving along the slot 412 of the first swing arm 401, drive the second swing arm 402 to rotate relative to the housing 100. The first end 201 is further configured to, when moving along the slot 412 of the second swing arm 402, drive the first swing arm 401 to rotate relative to the housing 100. By providing the slot 412, the dynamic interaction between the first swing arm 401 and the second swing arm 402 is enhanced, allowing the operator, through a simple displacement, to simultaneously control movement of the first swing arm 401 and the second swing arm 402, thereby improving operational flexibility and efficiency. In practical applications, the operator can quickly switch between two controls to meet diverse operational needs, which improves user experience and expands the application scope of the multi directional input device 10. Meanwhile, this design also ensures smoother and more accurate rotation of the swing arms, thereby improving overall operating precision and response speed.

Referring to FIG. 1, the multi-directional input device 10 further includes two rotation sensing members 500. The two rotation sensing members 500 are disposed on adjacent sides of the housing 100. The rotating portion 411 includes a third end 4110 extending along the axis of the rotating portion 411 away from the housing 100. The third end 4110 passes through the corresponding rotation sensing member 500. Each rotation sensing member 500 is configured to detect clockwise or counterclockwise rotation of the third end 4110 to determine whether the input is forward/backward or left/right. When the rotating portion 411 rotates due to tilting of the operation body 200, the rotation sensing member 500 can detect whether the third end 4110 rotates counterclockwise or clockwise and thereby determine whether the movement is forward/backward or left/right. The two rotation sensing members 500, arranged adjacent to and perpendicular to each other, can independently detect rotation of the third end 4110. This configuration enables the multi directional input device 10 to acquire rotation data in multiple directions, providing more comprehensive input feedback and control capability. Because the third end 4110 of the rotating portion 411 passes through the rotation sensing member 500, the device can respond in real time to the user’s operation. This direct coupling ensures that, during rotational input, the multi directional input device 10 accurately captures each movement, thereby improving input sensitivity and accuracy.

In some embodiments, the rotational axes of the rotating portions 411 of the first swing arm 401 and the second swing arm 402 are in a same horizontal plane. Setting the axes of the rotating portions 411 of the first swing arm 401 and the second swing arm 402 in the same horizontal plane helps maintain balance of the multi directional input device 10 when a force is applied, and reduces tilt or instability arising from angular differences. This design improves overall stability of the multi directional input device 10 to ensure precise and reliable operation even under vigorous operating conditions. It also reduces structural complexity in the vertical direction, saves space, and makes the multi directional input device 10 more compact and easier to integrate, which is particularly important for layout in practical applications, handheld devices, or compact platforms.

Referring to FIGS. 3 and 4, the multi-directional input device 10 further includes a cover 600. The cover 600 defines a latching groove 601, and the housing 100 includes a latching portion 106 configured to insert into the latching groove 601, so that the cover 600 is coupled to the housing 100. Preventing loosening caused by vibration or operation and thereby improving overall stability and durability of the multi directional input device 10. The latching groove 601 and the latching portion 106 partially overlap in projection, ensuring precise alignment during connection. This design enables the cover 600 to be correctly positioned at an appropriate location of the housing 100.

The cover 600 defines a second recess 602. The projection of the second recess 602 at least partially overlaps with the projection of the first recess 105, so that the cover 600 cooperates with the housing 100 to support the rotating portion 411 via the recesses 105 and 602. By providing overlapping projections between the second recess 602 of the cover 600 and the first recess 105 of the housing 100, the rotating portion 411 can be more securely fixed to the housing 100. A through hole 3021 is formed between the first recess 105 and the second recess 602, and the rotating portion 411 is arranged corresponding to the through hole 3021, thereby ensuring precise positioning of the rotating portion 411 within the housing 100.

Referring to FIGS. 4-6, the resetting assembly 300 includes an elastic member 301 disposed in the cavity 101 and a pressing plate 302 at an end of the elastic member 301 near the opening 104. The elastic member 301 presses the pressing plate 302 against the bottom surface 212, and one of the abutting edges 213 is configured to abut against a surface of the pressing plate 302 facing the opening 104. By cooperation of the elastic member 301 and the pressing plate 302, when no tilting operation is performed, the pressing plate 302 remains in abutment with the bottom surface 212. When a tilting operation is performed, an abutting edge 213 abuts against the pressing plate 302 to maintain a pronounced detent sensation. When resetting is required, the elastic member 301 promptly rebounds the operation body 200 so that it again abuts the bottom surface 212. The elastic member 301 not only provides the required restoring force so that the operation body 200 can be reset in the absence of an external force, but also provides effective resistance and feedback during input. During operation, whichever abutting edge 213 presses against the pressing plate 302 transmits force to the elastic member 301 and causes elastic deformation, thereby providing the operator with immediate tactile feedback. In addition, the overall design of the resetting assembly 300 simplifies the structure of the multi directional input device 10. During tilting operations in various directions, the operation body 200 presses against only the single elastic member 301, which significantly improves the consistency of the operator’s tactile sensation and, on the other hand, facilitates production and maintenance.

The housing 100 may further define a step surface 102 on a side of the pressing plate 302 facing the opening 104. A projection of the pressing plate 302 and a projection of the step surface 102 at least partially overlap with each other, so that the step surface 102 supports and positions the pressing plate 302. By arranging the step surface 102 such that its projection at least partially overlaps with the projection of the pressing plate 302, the pressing plate 302 can be better stabilized at a predetermined position, thereby reducing mis actuation or damage caused by movement during operation. Moreover, this design reduces operational error and improves input accuracy. The step surface 102 also serves a positioning function by providing a fixed reference surface for the pressing plate 302, enabling the elastic member 301 of the resetting assembly 300 to perform its restoring function more smoothly when the operation body 200 returns. Thus, the operator can obtain more consistent feedback during input, and both the contact between the pressing plate 302 and the abutting edge 213 and the return of the operation body 200 to its initial state maintain good mechanical consistency. The pressing plate 302 may be quadrilateral to correspond to the step surface 102.

Referring to FIGS. 5 and 6, the operation body 200 further includes a second end 202 extending through the bottom surface 212. The pressing plate 302 defines a through hole 3021, and the second end 202 extends through the through hole 3021. A press switch 103 is provided on a bottom wall of the housing 100. The second end 202 is configured to actuate the press switch 103 when the operation body 200 is pressed downward. The press switch 103, when being actuated, generates a corresponding instruction or command. This direct coupling improves the response speed of the multi directional input device 10 and reduces input delay, providing a smoother user experience. The configuration of the second end 202 allows the user to operate directly via the operation body 200. The through hole 3021 below allows the pressing plate 302 to move freely while not impeding the function of the second end 202.

In some embodiments, the abutting portion 210 further includes a hemispherical surface 211 connected to the operation surfaces 220. A bowl-shaped portion 1011 is formed in the cavity 101 and connected to the hemispherical surface 211 in a clearance fit manner, so that the operation member 20 can be titled in the cavity 101.

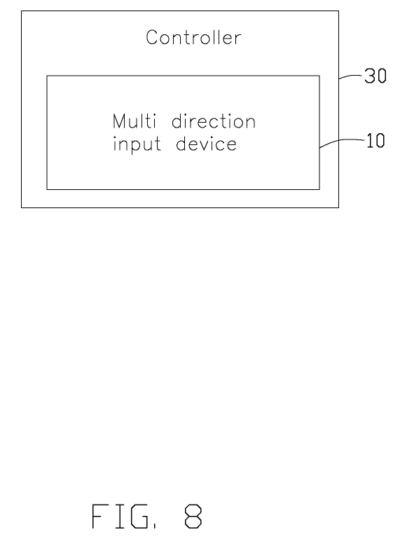

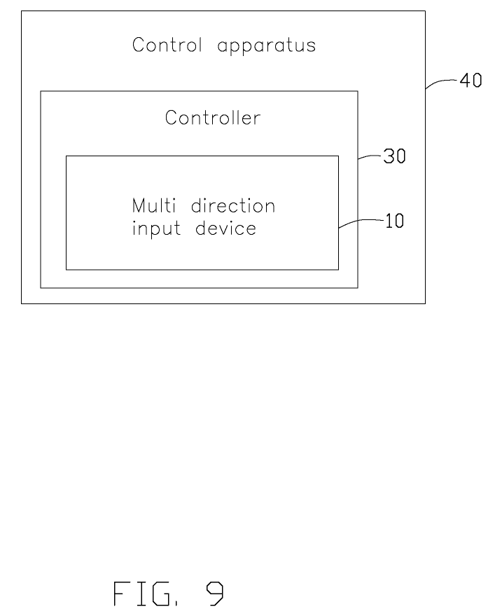

Referring to FIG. 8, a controller 30 includes the multi-directional input device 10. Referring to FIG. 9, a control apparatus 40 includes the controller 30. The control apparatus 40 may be, for example, a game console or an unmanned aerial vehicle.

The embodiments shown and described above are only examples. Many details are often found in the art such as the other features of the lens module 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A multi-directional input device, comprising:
a housing defining a cavity and an opening communicating with the cavity;
an operation member at least partially disposed in the cavity, such that, when acted upon by an external force, the operation member tilts or swings within the cavity, the operation member comprising an operation body and an abutting portion arranged around a periphery of the operation body, the operation body comprising a first end protruding from the opening, the abutting portion comprising a bottom surface facing away from the first end, the bottom surface comprising at least two abutting edges connected to one another; and
a resetting assembly disposed in the cavity and elastically abutting the bottom surface,
wherein the resetting assembly selectively abuts one of the at least two abutting edges when the operation member is tilted or swung within the cavity.

2. The multi-directional input device of claim 1, wherein the at least two abutting edges comprise four abutting edges connected to one another, the four abutting edges cooperatively define the bottom surface, and the abutting portion further comprises a plurality of operation surfaces on an outer wall of the abutting portion, each of the plurality of operation surfaces being perpendicular to or inclined relative to the bottom surface and connected to the bottom surface at a corresponding one of the four abutting edges.

3. The multi-directional input device of claim 1, wherein a plurality of posts extend from the bottom surface away from the first end, and one of the at least two abutting edges is formed between two of the plurality of posts.

4. The multi-directional input device of claim 2, further comprising a rocker arm assembly rotatably disposed on the housing and drivingly connected to the operation member, the rocker arm assembly being configured to rotate relative to the housing when the operation member is tilted or swung; the rocker arm assembly comprising a first swing arm and a second swing arm stacked one above the other and having rotational axes perpendicular to each other, the operation member being configured to drive the first swing arm or the second swing arm to rotate relative to the housing when one of the four abutting edges abuts the resetting assembly.

5. The multi-directional input device of claim 4, wherein each of the first swing arm and the second swing arm comprises an arm body and rotating portions located at two ends of the arm body, the housing defines a recess for rotatably receiving one of the rotating portions; the arm body defines a slot, at least a portion of the slot extending along an axial direction of the respective swing arm; the first end passes through and is configured to slide within the slot; the first end is configured to drive the second swing arm to rotate relative to the housing when the first end moves along the slot of the first swing arm, and is further configured to drive the first swing arm to rotate relative to the housing when the first end moves along the slot of the second swing arm.

6. The multi-directional input device of claim 1, wherein the resetting assembly comprises an elastic member disposed in the cavity and a pressing plate located at an end of the elastic member near the opening, the elastic member is configured to press the pressing plate against the bottom surface, and one of the at least two abutting edges is configured to abut a surface of the pressing plate facing the opening.

7. The multi-directional input device of claim 6, wherein the housing further defines a step surface on a side of the pressing plate facing the opening, a projection of the pressing plate overlaps a projection of the step surface, and the step surface is configured to support the pressing plate.

8. The multi-directional input device of claim 7, wherein the operation body further comprises a second end extending through the bottom surface, the pressing plate defines a through hole, the second end extends through the through hole, the housing comprises a press switch disposed on a bottom wall, and the second end is configured to actuate the press switch when the operation body is pressed.

9. A controller comprising a multi-directional input device, the multi-directional input device comprising:
a housing defining a cavity and an opening communicating with the cavity;
an operation member at least partially disposed in the cavity, such that, when acted upon by an external force, the operation member tilts or swings within the cavity, the operation member comprising an operation body and an abutting portion arranged around a periphery of the operation body, the operation body comprising a first end protruding from the opening, the abutting portion comprising a bottom surface facing away from the first end, the bottom surface comprising at least two abutting edges connected to one another; and
a resetting assembly disposed in the cavity and elastically abutting the bottom surface,
wherein the resetting assembly selectively abuts one of the at least two abutting edges when the operation member is tilted or swung within the cavity.

10. The controller of claim 9, wherein the at least two abutting edges comprise four abutting edges connected to one another, the four abutting edges cooperatively define the bottom surface, and the abutting portion further comprises a plurality of operation surfaces on an outer wall of the abutting portion, each of the plurality of operation surfaces being perpendicular to or inclined relative to the bottom surface and connected to the bottom surface at a corresponding one of the four abutting edges.

11. The controller of claim 9, wherein a plurality of posts extend from the bottom surface away from the first end, and one of the at least two abutting edges is formed between two of the plurality of posts.

12. The controller of claim 10, wherein the multi-directional input device further comprises a rocker arm assembly rotatably disposed on the housing and drivingly connected to the operation member, the rocker arm assembly being configured to rotate relative to the housing when the operation member is tilted or swung; the rocker arm assembly comprising a first swing arm and a second swing arm stacked one above the other and having rotational axes perpendicular to each other, the operation member being configured to drive the first swing arm or the second swing arm to rotate relative to the housing when one of the four abutting edges abuts the resetting assembly.

13. The controller of claim 12, wherein each of the first swing arm and the second swing arm comprises an arm body and rotating portions located at two ends of the arm body, the housing defines a recess for rotatably receiving one of the rotating portions; the arm body defines a slot, at least a portion of the slot extending along an axial direction of the respective swing arm; the first end passes through and is configured to slide within the slot; the first end is configured to drive the second swing arm to rotate relative to the housing when the first end moves along the slot of the first swing arm, and is further configured to drive the first swing arm to rotate relative to the housing when the first end moves along the slot of the second swing arm.

14. The controller of claim 9, wherein the resetting assembly comprises an elastic member disposed in the cavity and a pressing plate located at an end of the elastic member near the opening, the elastic member is configured to press the pressing plate against the bottom surface, and one of the at least two abutting edges is configured to abut a surface of the pressing plate facing the opening.

15. The controller of claim 14, wherein the housing further defines a step surface on a side of the pressing plate facing the opening, a projection of the pressing plate overlaps a projection of the step surface, and the step surface is configured to support the pressing plate.

16. The controller of claim 15, wherein the operation body further comprises a second end extending through the bottom surface, the pressing plate defines a through hole, the second end extends through the through hole, the housing comprises a press switch disposed on a bottom wall, and the second end is configured to actuate the press switch when the operation body is pressed.

17. A control apparatus comprising a controller including a multi-directional input device, the multi-directional input device comprising:
a housing defining a cavity and an opening communicating with the cavity;
an operation member at least partially disposed in the cavity, such that, when acted upon by an external force, the operation member tilts or swings within the cavity, the operation member comprising an operation body and an abutting portion arranged around a periphery of the operation body, the operation body comprising a first end protruding from the opening, the abutting portion comprising a bottom surface facing away from the first end, the bottom surface comprising at least two abutting edges connected to one another; and
a resetting assembly disposed in the cavity and elastically abutting the bottom surface,
wherein the resetting assembly selectively abuts one of the at least two abutting edges when the operation member is tilted or swung within the cavity.

18. The control apparatus of claim 17, wherein the at least two abutting edges comprise four abutting edges connected to one another, the four abutting edges cooperatively define the bottom surface, and the abutting portion further comprises a plurality of operation surfaces on an outer wall of the abutting portion, each of the plurality of operation surfaces being perpendicular to or inclined relative to the bottom surface and connected to the bottom surface at a corresponding one of the four abutting edges.

19. The control apparatus of claim 17, wherein a plurality of posts extend from the bottom surface away from the first end, and one of the at least two abutting edges is formed between two of the plurality of posts.

20. The control apparatus of claim 18, wherein the multi-directional input device further comprises a rocker arm assembly rotatably disposed on the housing and drivingly connected to the operation member, the rocker arm assembly being configured to rotate relative to the housing when the operation member is tilted or swung; the rocker arm assembly comprising a first swing arm and a second swing arm stacked one above the other and having rotational axes perpendicular to each other, the operation member being configured to drive the first swing arm or the second swing arm to rotate relative to the housing when one of the four abutting edges abuts the resetting assembly.
